(19) United States
(12) Patent Application Publication
(10) Pub. No.: US 2006/0023300 A1
(43) Pub. Date: Feb. 2, 2006

(54) Device for optically viewing a stereoscopic observation beam path

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 10/536,567

(22) PCT Filed: Dec. 1, 2003
(86) PCT No.: PCT/EP03/13493

§ 371 Date: May 26, 2005

(30) Foreign Application Priority Data
Nov. 29, 2002 (DE) 10255967.8

(51) Int. Cl. G02B 21/22

(52) U.S. Cl. 359/376

(57) ABSTRACT

The invention concerns an apparatus for reflecting at least one stereoscopic observation beam path out of a main observation beam path of a microscope, for example a surgical stereomicroscope, having a zoom (6) whose axis is arranged at an angle to the optical axis (4) of the main objective (2), and having a beam splitter (7) for reflecting out stereoscopic assistant's observation beam paths (9a, b). The beam splitter (7) is arranged between the main objective (2) and the zoom (6), and is continuously rotatable, together with the assistant's microscope (8), about the optical axis (4) of the main objective (2), and is thus optically usable in any rotational position.

### CROSS-REFERENCE TO RELATED APPLICATIONS

The present application is the U.S. National Stage of International Application No. PCT/EP2003/013493 filed Dec. 1, 2003, which claims priority of German Application No. 102 55 967.8 filed Nov. 29, 2002.

### FIELD OF THE INVENTION

The invention concerns an apparatus or device for reflecting at least one stereoscopic observation beam path out of a microscope, for example a surgical stereomicroscope.

### BACKGROUND OF THE INVENTION

In neurosurgery and ophthalmology, it is desirable for two equally qualified operators (surgeon and assistant) to be able to follow surgical occurrences under the microscope. From a very early date, numerous possibilities have already been offered for combining two microscopes with one another:

German Examined Application DE-AS 1 217 099 discloses, in a number of variants, a stereomicroscopic device which comprises at least two stereomicroscopes M₁ and M₂ having a shared object plane, and which permits simultaneous observation of the surgical field by two or more persons. In such devices, a combination of reflectors (splitter prisms) ensures that the axes of the individual observation beam paths between objective and object coincide. The reason such microscopes have not proven successful on the market is because, as shown in FIG. 1 of this publication, the splitter prism is arranged beneath main objectives O₁ and O₂ of microscopes M₁ and M₂, and results there in an astigmatism in the convergent beam path that is not correctable because of the rotation of microscope M₂ around M₁. As variant embodiments thereof, Figures are depicted in this Examined Application in which the splitter prism is located above main objective O_{H}. It is disadvantageous in this context that the beam path is extremely long and thus results in further optically necessary corrective actions, for example for pupil location. Combinations of deflection elements, as proposed in FIG. 2 through FIG. 7 of DE-AS 1 217 099, lead to unavoidable vignetting because of the long glass paths. With this principle of combining two vertically configured microscopes parallel to one axis, the overall height is moreover very large. This results in ergonomic disadvantages that are very significant especially in the context of surgical microscopes.

It has been possible to eliminate some of these disadvantages (cf. documents DE-C2 33 33 471 and U.S. Pat. No. 4,605,287). For example, the beam splitter has been replaced by a thin splitter plate in the convergent beam path beneath the main objective. Astigmatism is thereby avoided, but bothersome double images are produced. One embodiment is described in the Leica brochure “0° assistant's microscope, stereo—For assisting and training in ophthalmology,” document no. M1-665-0en, publication annotation VI.98 (June 1998).

Another approach is presented in DE-C2 43 31 635. In this special microscope for ophthalmology, the beam splitter element is arranged above the shared main objective. To reduce the overall height, a particularly low deflection element was designed that nevertheless allows mechanical, but not optical, rotation of the assistant's microscope around the main microscope. The only capability that therefore exists is that of using the assistant's microscope exclusively to the right or left of the main microscope. Use of this system is thereby confined to ophthalmology, and it is not sufficiently usable in neurosurgery. This is because in neurosurgery it is necessary for the assistant's microscope to be continuously pivotable, mechanically and optically, around the main microscope. In general, this microscope has the advantage that no astigmatism occurs; there are also no double images produced, and the overall height is sufficiently low.

DE-A1-195 41 420 describes a microscope in which the illumination device can be arranged in at least two positions relative to the main microscope. For example, a reflecting-out system for an assistant's microscope is described, that system being arranged rotatably about the axis of the main microscope and between the objective and that main microscope. In the system described, this results in a large and ergonomically unfavorable overall height, as well as vignetting and reflections that are bothersome to the observer.

US-A1-2001/0010592, on the other hand, describes a microscope in which a horizontally located two-channel zoom system is proposed in order to reduce the overall height. A beam splitter is arranged with the assistant's microscope beneath the main objective. As a result, an interface is available from which the assistant's microscope can selectably be removed. One disadvantageous consequence, however, is that each microscope requires its own main objective, which optionally must be electromechanically coupled to one another. Usability is also limited because no rotation is possible. Because the illumination beam path also passes through the beam splitter of the assistant's microscope, reflections occur there that are extremely difficult to eliminate. The observation beam path passes divergently through this beam splitter, thus resulting in troublesome vignetting. An additional consequence of this arrangement of the beam splitter is an astigmatism that depends on the orientation of the assistant's microscope relative to the main microscope.

### SUMMARY OF THE INVENTION

It is thus the object of the present invention to create an apparatus with which at least one stereoscopic observation beam path for an assistant's microscope can be reflected out in optically and mechanically continuously rotatable fashion, while avoiding all the aforementioned disadvantages.

This object is achieved in that a beam splitter for reflecting out the assistant's stereoscopic observation beam paths is arranged between the main objective and the zoom of the main microscope and is continuously rotatable, together with the assistant's microscope, about the optical axis of the main microscope, and is thus optically usable in any rotational position. “Continuously rotatable” is understood to mean a rotation about the optical axis of the main objective that makes possible any rotation angle about the axis, steplessly and/or in steps. In order to decrease the overall height of the main microscope, the arrangement of the beam splitter is combined, according to the present invention, with a zoom whose axis deviates from the optical axis of the microscope. This zoom comprises two optical systems of identical type that are preferably located perpendicular to the optical axis of the main objective. There is therefore a zoom in each stereoscopic partial beam path.

Further embodiments represent, for example, obliquely located, non-parallel optical channels in the zoom.

The beam splitter can effect geometric or physical beam splitting and can be embodied as a splitter cube, splitter plate, or pellicle, or can even comprise an LCD element.

As a result of the arrangement of the beam splitter between the main objective and the zoom, all the optically necessary corrections can be performed, or are in fact not needed, since no astigmatism, no double images, no reflections resulting from the illumination, and no vignetting occur. Furthermore, the main observation beam paths and the assistant's observation beam paths pass through the shared main objective, with the additional advantageous consequence that a separate objective for the assistant's microscope, with an electromagnetic coupling to the main objective, is not necessary.

As a further embodiment, the assistant's microscope can be removed from the microscope by way of a mechanical detachment point. As a variant of this, the assistant's microscope can be selectably removed from the main microscope with or without the beam splitter.

The assistant's microscope can furthermore contain, in the region between the beam splitter and a deflection element of the assistant's microscope, optical components (spherical and/or plane optics) that make it possible to modify this aforesaid spacing between the beam splitter and deflection element. If the deflection element is designed rotatably through an angle relative to the beam splitter about the axis of the assistant's microscope, there is then room in the region between beam splitter and deflection element for optical image reversal elements, for example Dove prisms.

The main objective that is used in shared fashion can be designed for a fixed or a variable focal length. In particular in the context of a variable focal length for the main objective, it is useful to guide the illumination through the main objective, i.e. to arrange it between the main objective and the splitter prism. This automatically ensures that the illuminated field is always in the correct location and is correlated with the size of the object field. The overall height is, however, disadvantageously increased. To prevent this, it is advisable to use the “Objective with illumination” described in the German Patent Application bearing the official application no. 102 35 706.4, which corresponds to commonly owned U.S. patent application Ser. No. 10/628671 filed Jul. 28, 2003. This main objective, used in shared fashion by the main and assistant's observation beam paths as well as the illumination beam path, is separated into one objective part for observation and a second objective part for illumination, the objective part for illumination being removed from the main objective and arranged at an angle to the optical axis of the main objective.

The “Objective with illumination” described above can be selectably rotated about the optical axis of the main objective.

### BRIEF DESCRIPTION OF THE DRAWINGS

The present invention is described below in more detail with reference to the Figures.

The Figures are described in interconnected and overlapping fashion. Identical reference characters denote identical components; reference characters with different indices indicate functionally identical components.

In schematic fashion,

FIG. 1 shows, in a side view, the overall configuration of an optical viewing apparatus according to the present invention; and

FIG. 2 shows, in a plan view, a detail of the apparatus depicted in FIG. 1 having a rotatable beam splitter.

### DETAILED DESCRIPTION OF THE INVENTION

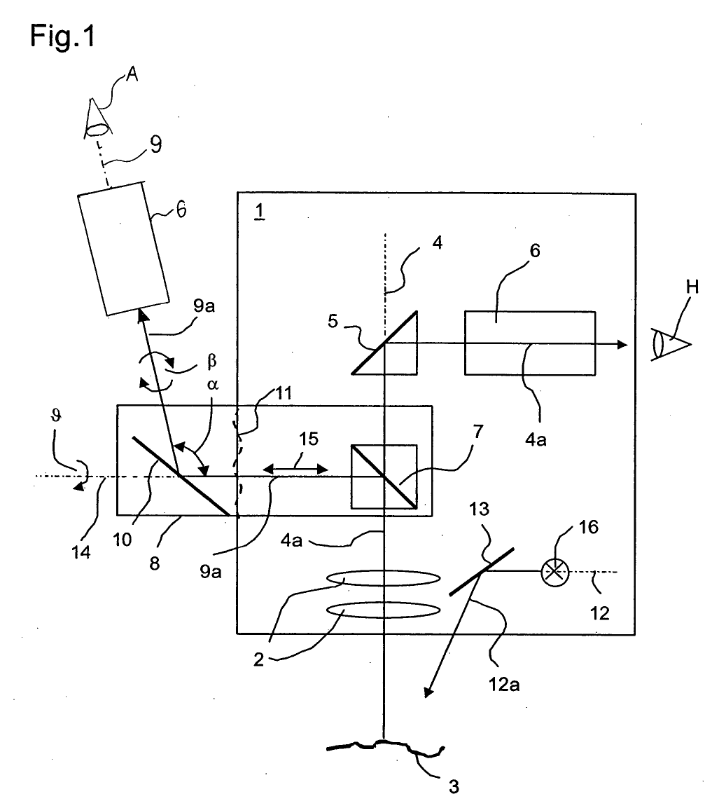

FIG. 1 depicts: a main microscope 1, with a surgeon as main observer H, having a main objective 2 with a vertical optical axis 4; an object 3; and an assistant's microscope 8 for an assistant A. An illumination beam path 12a having an axis 12, proceeding from a light source 16, is projected through a deflection element 13 onto an object 3 (e.g. a patient). Object 3 is imaged by way of stereoscopic main observation beam paths 4a, b, via a main objective 2, a beam splitter 7, and a further 5 deflection element 5, into a horizontally located zoom 6. Optionally, the main objective 2 may be arranged rotatably, together with the illumination system, for rotation about the optical axis 4 of the main objective 2.

As a consequence of the side view of main microscope 1, only one 4a of the two stereoscopic main observation beam paths 4a, b, one 9a of the two assistant's observation beam paths 9a, 9b, and one of the two zooms 6 of identical type, are visible in FIG. 1. The manner of operation of the main and assistant's observation beam paths 4a, 9a, as described below, is also analogously applicable to observation beam paths 4b, 9b.

Further components that are important for the operation of the microscope, such as the binocular tube and eyepieces, are not depicted in this Figure in the interest of simplicity.

Beam splitter 7 splits main observation beam path 4a into two partial beam paths. Beam splitter 7 sends the one partial beam path on as main observation beam path 4a. The other partial beam path is reflected by beam splitter 7 out of main observation beam path 4a as assistant's observation beam path 9a. This assistant's observation beam path 9a is directed via a further deflection element 10 into a binocular tube with eyepieces (not depicted in this Figure in the interest of simplicity). As a result of its arrangement, this deflection element 10 makes possible a tilting and thus a deflection, through a modifiable angle equal to a magnitude α, of observation beams 9a, b for assistant A.

The binocular tube (not depicted) can be arranged rotatably about an optical axis 9, lying between assistant's observation beam paths 9a and 9b, of assistant's microscope 8, and can thus enable a rotation through angle β of assistant's observation beam paths 9a, b.

Assistant's microscope 8 can be, for example, detachable from main microscope 1 at a mechanical detachment point 11.

A spacing variation 15 indicates the possibility of varying the spacing between beam splitter 7 and deflection element 10. The possibility additionally exists of rotating deflection element 10 relative to beam splitter 7, through an angle θ, about an axis 14 that lies between the two assistant's observation beam paths 9a, b.

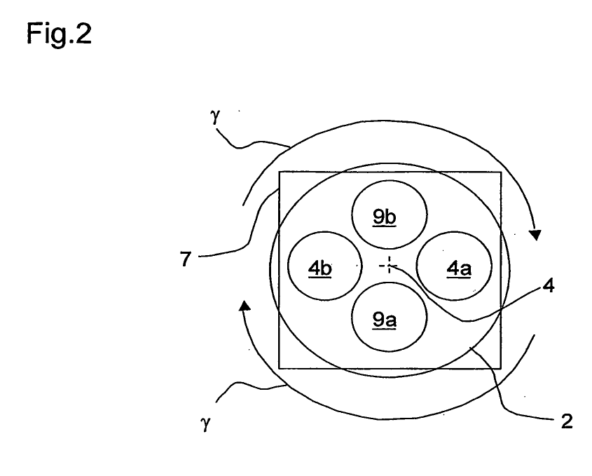

FIG. 2 illustrates a rotation γ of beam splitter 7 that is accomplished continuously about optical axis 4 of main objective 2. Also depicted are main observation beam paths 4a, b, as well as assistant's observation beam paths 9a, b. The outline of main objective 2 is visible as a projection into the plane of beam splitter 7. According to the present invention, beam splitter 7 is rotated together with assistant's microscope 8 (not depicted in this Figure).

### PARTS LIST

1 Main microscope for (H)

2 Main objective

3 Object (illuminated field)

4 Optical axis of (2)

4a, b Main observation beam path

5 Deflection element for (4a, b)

6 Zoom

7 Beam splitter

8 Assistant's microscope for (A)

9 Optical axis of (8)

9a, b Assistant's observation beam path for (A)

Deflection element for (9a, b)

11 Mechanical detachment point

12 Axis of (12a)

12a Illumination beam path

13 Deflection element for (12a)

14 Horizontal axis of (8)

15 Spacing variation between (7) and (10)

16 Light source

α Tilt of (10)

β Rotation of (9a, b)

γ Rotation of (7)

θ Rotation angle about (14)

A Assistant

B Main observer (surgeon)

1.-13. (canceled)

14. An apparatus comprising:
a main microscope (1) including a main objective (2) having an optical axis (4), a pair of main stereoscopic observation beam paths (4a, 4b) passing through the main objective (2), and a zoom (6) in the main observation beam paths (4a, 4b), the zoom having an axis arranged at an angle to the optical axis (4) of the main objective (2);
an assistant's microscope (8); and
a beam splitter (7) arranged in the main observation beam paths (4a, 4b) between the main objective (2) and the zoom (6) for reflecting out a pair of assistant's stereoscopic observation beam paths (9a, 9b) to the assistant's microscope;
wherein the beam splitter (7) is continuously rotatable, together with the assistant's microscope (8), relative to main microscope (1) about the optical axis (4) of the main objective (2), whereby the beam splitter (7) and assistant's microscope (8) are optically usable in any rotational position.

15. The apparatus according to claim 1, wherein the zoom (6) includes an optical system in each of the pair of main stereoscopic observation beam paths.

16. The apparatus according to claim 1, wherein the axis of the zoom (6) extends substantially perpendicular to the optical axis (4) of the main objective (2).

17. The apparatus according to claim 1, wherein the assistant's microscope (8) is mechanically detachable from the main microscope (1).

18. The apparatus according to claim 17, wherein the beam splitter (7) is mechanically detachable from the main microscope (1) together with the assistant's microscope (8).

19. The apparatus according to claim 14, wherein the assistant's microscope (8) includes a deflection element (10) for receiving the pair of assistant's stereoscopic observation beam paths (9a, 9b) along an assistant's microscope axis (14) and redirecting the pair of assistant's stereoscopic observation beam paths (9a, 9b) into an assistant's binocular tube.

20. The apparatus according to claim 19, wherein the assistant's microscope (8) further includes optical components in the assistant's microscope axis (14) between the beam splitter and the deflection element (10), the optical components enabling a spacing variation (15) and/or providing an image rotation between the beam splitter (7) and the deflection element (10).

21. The apparatus according to claim 19, wherein the deflection element (10) is rotatable relative to the beam splitter (7) about the assistant's microscope axis (14).

22. The apparatus according to claim 14, wherein the rotation of the beam splitter (7) together with the assistant's microscope (8) is drivable in motorized or manual fashion.

23. The apparatus according to claim 19, wherein the deflection element (10) is rotatable relative to the beam splitter (7) to vary a tilt angle (α) between the assistant's microscope axis (14) and the direction of the pair of assistant's stereoscopic observation beam paths (9a, 9b) after redirection by the deflection element (10).

24. The apparatus according claim 14, wherein the main objective (2) has a fixed focal length.

25. The apparatus according claim 14, wherein the main objective (2) has a variable focal length.

26. The apparatus according to claim 14, wherein the main microscope (1) further comprises an illumination beam path (12a) directed through the main objective (2).

27. The apparatus according to claim 26, wherein the main objective (2) is divided into at least two parts.

28. The apparatus according to claim 27, wherein one part of the main objective (2) is used for the main observation beam paths (4a, b) of the main microscope (1), and another part of the main objective (2) is used for the illumination beam path (12a).

29. The apparatus according to claim 26, wherein the main objective (2) is rotatable, together with the illumination beam path (12a), about the optical axis (4) of the main objective (2).
